(19) United States
(12) Patent Application Publication
(10) Pub. No.: US 2015/0201647 A1
(43) Pub. Date: Jul. 23, 2015

(54) FOOD PRODUCTS CONTAINING ZEIN, AND RELATED PROCESSES

(71) Applicant: POET Research, Inc., Sioux Falls, SD (US)

(72) Inventors: Lawrence E. Fosdick, Sioux Falls, SD (US); Julie Y. Kindelspire, Sioux Falls, SD (US); Christoph Lawrence Bausch, Sioux Falls, SD (US); John W. Lawton, JR., Sioux Falls, SD (US)

(21) Appl. No.: 14/599,776

(22) Filed: Jan. 19, 2015

Related U.S. Application Data
(60) Provisional application No. 61/929,273, filed on Jan. 20, 2014.

(51) Int. Cl. A23J 1/12; A21D 2/26

(52) U.S. Cl. CPC A23J 1/12; A21D 2/265

(57) ABSTRACT

Described are food compositions and methods of preparing food compositions, the food compositions containing a zein protein material that includes alpha-zein, beta-zein, and gamma-zein.

### PRIORITY CLAIM

This application claims priority to U.S. Provisional Application Ser. No. 61/929,273, filed Jan. 20, 2014, entitled “FOOD PRODUCT CONTAINING ZEIN, AND RELATED PROCESSES,” which is herein incorporated by reference in its entirety.

### FIELD OF THE INVENTION

The invention relates to food products and processing of food products, wherein the food product includes zein protein.

### BACKGROUND

Zein is a protein material derived from corn and belonging to a class of proteins called prolamines. Approximately forty to fifty percent of the total protein in corn is zein, or about four percent of the corn kernel on a dry basis. Zein is further categorized into four types: alpha-zein, beta-zein, gamma-zein, and delta-zein. Each zein type has a different amino-acid profile and exhibits slightly different physical properties. Zein as a corn substituent includes all four types, with alpha-zein being present at about seventy percent of total zein. Beta-zein accounts for about five percent of the zein in corn. Gamma-zein accounts for approximately twenty to twenty-five percent of the zein in corn, and delta-zein accounts for about one to five percent of the zein in corn.

Zein can be extracted and recovered from corn or co-products of corn processing. The composition and characteristics of the resulting zein material may depend on the process used on the corn and the method of zein recovery, including in certain recovery processes a solvent for an extraction step. Two major types of corn processing are wet milling and dry milling. Wet milling begins with steeping the corn in the presence of reduced sulfur, such as sulfite, to loosen the pericarp, followed by milling and separation of the major components such as germ, endosperm, pericarp, and protein. The corn proteins are divided between the steep liquor and the byproduct corn gluten meal (CGM). Dry milling is carried out without steeping, and in the case of ethanol production, preliminary separation of corn components is not typically done. Corn Gluten Meal from the wet milling process is a typical starting material for zein extraction due to its high protein content (sixty percent or greater). However, the sulfite or other chemicals that may be used during the preparation (e.g., in a steeping process) of CGM may adversely affect zein quality.

Up to now, zein has been found to have a degree of usefulness in commercial food and polymer-related technologies. Zein has been used as a raw material for a variety of non-toxic and renewable polymer applications. Some zein compositions have been classified as GRAS (Generally Recognized As Safe) by the U.S. Food and Drug Administration. Zein has been used on a limited basis in certain useful capacities, for example in preparing edible food packaging, edible films, biodegradable plastic resins, chewing gum base, tablet-coating compounds, adhesives, coatings for paper cups, and soda bottle cap linings. Zein can also be processed into resins and other bioplastic polymers, which can be extruded or rolled into a variety of plastic products.

In the food technologies, zein has not yet become widespread as a food ingredient. While zein is a protein and can be prepared to be GRAS for certain applications, zein has not been found to provide particular utility or advantage as a food ingredient and is not in widespread use as a food ingredient.

Demand is continuous for new food ingredients that may be useful or advantageous in providing good nutrition, low cost, or improved flavor or sweetness as a food ingredient. As one example, food scientists continue to search for ways to reduce amounts of sugar in food products, such as by reducing a sugar level of a food product and replacing the amount of removed sugar with a bulking agent or other low cost ingredient that may or may not be of high nutritional value or provide any flavor or texture. As another example, food scientists are currently interested in preparing food products that are low in gluten or that are gluten-free. Also desired by some consumers are food products that contain reduced or low amounts of carbohydrates. Ingredients that could be useful to produce reduced sugar food products, reduced gluten or gluten-free food products, low carbohydrate food products, etc., are highly sought.

### SUMMARY

The present invention relates to food products and methods of preparing food products that contain zein as a food ingredient. As presented in the following description, Applicant has determined that certain types of zein compositions that contain more than insignificant levels of the beta- and gamma-zein forms in addition to the alpha-form of zein, can be useful in food processing to prepare useful food products. These zein compositions may also include a delta-form of zein in a relatively small amount; the zein composition may be referred to herein as alpha-beta-gamma-containing zein compositions (or “alpha-beta-gamma-containing zein” for short).

In a general sense, the alpha-beta-gamma-containing zein compositions have now been identified as being useful in certain specific types of food products as a food ingredient that may function to provide structure or bulk properties and optionally to replace other less desirable food ingredients. Advantageously, the zein compositions allow for a “clean” food label, meaning that the zein material can be listed as a protein-type ingredient on an ingredient panel of a food label.

In determining that the alpha-beta-gamma-containing zein compositions are useful as food ingredients as described herein, Applicant has demonstrated that these zein compositions exhibit certain useful or advantageous food processing properties that can allow for their use in processed food products. As one example, Applicant has now determined that the alpha-beta-gamma-containing zein compositions exhibit increased foaming and emulsifying capacity relative to other zein compositions containing higher amounts of alpha-zein and lower amounts of beta- and gamma-zein. In example two, the applicant has determined that the extruded product containing alpha-beta-gamma containing zein can have better textural attributes compared to other zein materials that include substantially all alpha-zein. The alpha-beta-gamma-containing zein is shown to be capable of being processed by extrusion to form a “puffed,” “expanded,” or “extruded” food product with the zein protein as a structural protein present as a continuous phase of a structural matrix or cell-wall of the food product. In comparison, previous zein protein compositions that include substantially all alpha-zein and only insubstantial amounts of beta- and gamma-zein, are less capable or incapable of being used as a structural protein in this manner, in a food product.

Embodiments of extruded food products can be formed from a dough that includes the alpha-beta-gamma-containing zein composition described herein along with added water and additional optional ingredients such as fillers, flavorants, and other useful food ingredients, as desired. The ingredients are combined into the dough by any manner and the dough is extruded under pressure and expands or becomes puffed, then is dried. Optionally, the filler or additional food ingredients can include a carbohydrate, fat, sugar or other flavorant, and the expanded or puffed food product may have a coating applied at a surface. The extruded, expanded food product has a cellular structure made of dried open or closed cells defined by cell walls, the cellular structure being referred to herein as a dried “matrix” that is separated by the space of the cells. The matrix is made of the expanded and dried dough and includes the alpha-beta-gamma-containing zein, for example with the alpha-beta-gamma-containing zein being a continuous phase of the matrix that is understood to function as a structural support of the matrix and the food piece, i.e., as a structural protein. The dried food piece can have sufficient structure to support its own weight during and after drying of the expanded dough piece. The food product is dried to a moisture content to provide a crisp or frangible product.

A useful zein composition can be any zein composition that includes each of the beta- and gamma-zein forms in more than an insubstantial amount, in addition to an amount of alpha-zein, and also optionally in addition to a relatively low amount of delta-zein. The amounts of each form of zein can preferably be as described herein, and preferably will be amounts of each that result in processing properties of the zein composition that allow the zein composition to be processed into a food product as described, including food products having useful end product features such as desirable taste, texture, and flavor. Accordingly, the specific amounts and relative amounts of the alpha-, beta-, gamma-, and (optional) delta-zein forms can be as desired and as are determined to be useful for processing into food products as described herein.

By way of example, alpha-beta-gamma-containing zein compositions determined to be useful with the presently-described methods of processing food products, and the resultant food products, include the beta- and gamma-zein forms in an amount of from 12 to 60 percent by weight total combined beta- and gamma-zein forms, based on the total of all forms of zein in an alpha-beta-gamma-containing zein composition. The alpha-beta-gamma-containing zein compositions also can include a delta-zein form, and possibly others, in relatively low amounts such as up to about 5 percent based on total zein. In other embodiments, beta- and gamma-zein (total) content may be even higher, such as at least 25, 35, or 40 percent by weight beta- and gamma-zein based on total weight zein (as used herein, the terms “total weight zein” and “total zein” (used without a designated zein form or zein forms) refer to all types of zein in a described zein composition, including any one or combination of alpha-, beta-, gamma-, delta-zein, or any other form of zein).

The alpha-beta-gamma-containing zein composition may be derived from native corn of any corn type or variety, the corn being either natural (non-genetically modified) or genetically modified. According to the latter, the protein sequence and structure of each of the different zein forms derived from a genetically modified corn may be identical to those of the same zein form (e.g., alpha-, beta-, gamma-) derived from a natural corn, or may differ in a manner that does not result in a significant performance difference relative to the ability of the protein to function as described herein, in preparing a food product as described. For example a sequence of a zein form (e.g., alpha-, beta-, gamma-zein) derived from a genetically modified corn may be at least 95 or at least 99 percent identical to a respective zein form of the corresponding non-genetically modified corn.

In exemplary embodiments, an alpha-beta-gamma-containing zein composition may contain from 40 to 88 weight percent alpha-zein and from 12 to 60 weight percent combined beta-zein and gamma-zein; or from 55 to 70 weight percent alpha-zein, from 2 to about 8 weight percent beta-zein, and from about 5 to 25 weight percent gamma-zein; or from 60 to 70 weight percent alpha-zein, from 3 to 7 weight percent beta-zein, and from 10 to 20 weight percent gamma-zein. Each of these compositions may also include a small amount of delta-zein, e.g., less than 5 percent based on total weight zein.

In one aspect, the invention relates to a food product that includes a structural matrix defining openings between structural matrix walls. The structural matrix includes zein present as a continuous phase of the structural matrix. The food product contains at least 6 weight percent zein on a dry basis (as used herein, the term “dry basis” refers to all non-water materials in the food product).

In another aspect the invention relates to a food product that includes a structural matrix defining openings between structural matrix walls. The structural matrix includes zein as a continuous phase of the structural matrix, and the food product is not popcorn.

In yet another aspect, the invention relates to a method of preparing an expanded food product that includes a structural matrix defining openings between structural matrix walls. The method includes: providing a dough mixture comprising zein, heating the dough mixture, extruding the dough mixture, and drying the extruded dough mixture to form a dried expanded food product.

### BRIEF DESCRIPTION OF THE DRAWING

FIG. 1 shows protein performance data.

### DETAILED DESCRIPTION

The following description, including the example, relates to food products and food processing methods that use zein protein as a food ingredient. The zein compositions used in the processing and food products contain more than insignificant amounts of the beta- and the gamma-zein forms, in addition to an amount of the alpha-zein form and an optional small amount of delta-zein form. These “alpha-beta-gamma-containing zein compositions” have now been found to be particularly useful in food processing and as an ingredient in food products.

The zein composition can include any useful or advantageous amounts and relative amounts of the alpha-, beta- and gamma-zein forms, consistent with the present description. Preferred amounts and relative amounts of the different zein forms can allow a food composition (e.g., dough) that contains the alpha-beta-gamma zein composition to be efficiently processed into a food product as described herein, e.g., a food product that exhibits useful end product features such as desirable taste, texture, flavor, size, crispiness, etc. Accordingly, the specific amounts and ratios of the alpha-, beta-, and gamma-zein forms can be as desired and as determined to be useful for desired processing of a food product as described herein.

The amounts and relative amounts of the alpha-, beta-, and gamma-zein forms in useful alpha-beta-gamma zein compositions make the alpha-beta-gamma zein compositions different from certain previous zein compositions that contain substantially or entirely the alpha form of zein. Alpha-zein is the most hydrophobic cereal prolamin (Belitz et al 1986). Alpha-zein also may have amphipathic properties (di Gioia and Guilbert 1999), having both polar and nonpolar regions within its structure. Beta- and gamma-zeins are less hydrophobic than alpha-zein and have a greater affinity for water (Esen 1986). The 27 kDa gamma-zein is water soluble in its reduced peptide form (Lawton and Wilson 2003).

Another feature of the alpha-beta-gamma-containing zein compositions is a relatively high cysteine content compared to previous zein compositions, e.g., levels of cysteine that are higher relative to the amount of cysteine present in a zein composition containing lower amounts of beta- and gamma-forms of zein, e.g., that contain only or substantially only (e.g., at least 90, 95, or 98 percent of) the alpha-form of zein. The alpha-beta-gamma-containing zein compositions include higher relative amounts of the beta- and gamma-zein forms as compared to zein compositions that contain substantially all alpha-zein, and the beta- and gamma-forms of zein include 12 and 15 cysteine residues per protein molecule, respectively. Cysteine enables a zein protein molecule to form disulfide bonds. In contrast, alpha-zein contains a single cysteine residue per protein molecule.

A zein composition useful for the described food processing and food products can be any zein composition that is consistent with the broadest descriptions herein, having described amounts of the alpha-, beta-, and gamma-zein forms. Examples of zein compositions that have been determined to be useful with processes and products as described herein are described in Applicant's United States Patent application 2011/0143013 (“the '013 patent application” filed Dec. 10, 2010, the entirety of which is incorporated herein by reference). The '013 patent publication describes certain zein compositions derived from corn as a co-product of a fermentation process that is also useful to produce ethanol. Zein compositions described in the '013 patent application can be efficiently produced by these methods in substantial volume, will contain amounts of each of the alpha-, beta-, gamma-, and delta-zein forms, and as shown herein can exhibit useful or advantageous processing properties that can allow the zein to be useful in a variety of food products.

Useful zein compositions include greater than an insubstantial amount of each of the three forms of zein proteins known as the alpha-, beta- and gamma-forms, e.g., greater than 0.5 percent by weight of each form, or greater than 1 percent by weight of each form based on a total weight of the zein (all forms) in the zein composition. According to certain embodiments, the beta- and gamma-zein forms may be present at from 12 to 60 percent (by weight) of the total zein (all forms) in an alpha-beta-gamma zein composition. In other embodiments, beta- and gamma-zein content may be higher, such as at least 25, 35, or at least 40 percent by weight beta- and gamma-zein based on a total amount (weight) of zein (all forms) in an alpha-beta-gamma zein composition. In these or other embodiments the zein composition may contain from 40 to 88 weight percent alpha-zein and from 12 to 60 weight percent combined beta-zein and gamma-zein; or from 55 to 70 weight percent alpha-zein, from 2 to 8 weight percent beta-zein, and from 5 to 25 weight percent gamma-zein; or from 60 to 70 weight percent alpha-zein, from 3 to about 7 weight percent beta-zein, and from 10 to 20 weight percent gamma-zein. These alpha-beta-gamma zein compositions can also contain delta-zein form, e.g., from about 1 to about 5 weight percent delta-zein based on total zein (all forms).

The alpha-beta-gamma-containing zein composition can be prepared by any useful method of isolating these protein constituents from a raw material such as corn, which may be genetically modified or non-genetically modified. One useful method is described at Applicant's co-pending United States Patent application 2011/0143013. That patent application describes concentrated zein compositions derived from corn as a co-product of ethanol processing by fermentation. The described alpha-beta-gamma zein compositions are different in their chemical makeup relative to many previous zein compositions, based on the amounts of different forms of zein in the respective zein compositions, i.e., the relative amounts of the alpha-zein, beta-zein, and gamma-zein forms. The described zein compositions can be efficiently produced by fermentation methods at a quality level that will allow for a food quality (preferably GRAS) alpha-beta-gamma zein composition, and can be listed as a protein-type ingredient on an ingredient panel of a food label. The concentrated zein composition can preferably be in the form of a food ingredient that contains at least 70, 75, 80, 90, or 95 weight percent zein (all forms) on a “dry” or “solids” basis, i.e., as a percentage of the total weight of solids (non-water materials) in the concentrated zein composition.

In use, an alpha-beta-gamma-containing zein composition can be combined with other food ingredients and water to make a dough that can be processed into a food product. The dough can include a desired amount of solid ingredients in useful amounts and ratios, including the alpha-beta-gamma-containing zein composition, along with other food ingredients such as additional carbohydrates such as flour and starch; fiber; fat (e.g., solid fat or oil); additional protein (e.g., for added nutritional value); and one or more flavorant such as sugar, cheese, or other natural or artificial flavor, and other optional additives and preservatives as desired. The relative amounts of each of these additional food ingredients can be selected to achieve desired flavor and texture of the finished food product, as well as mechanical properties of the dough for processing.

A food product prepared to include the alpha-beta-gamma-containing zein composition may contain any useful amount of the zein composition. A useful amount can be selected based on the type and character of the food product being prepared, including features such as taste, nutritional requirements, and physical (e.g., mechanical, cosmetic) properties thereof. An amount of the alpha-beta-gamma-containing zein that can be useful for producing an extruded food product is any amount that in combination with other ingredients is sufficient to produce a dough capable of being extruded to produce an expanded and then dried food product that includes a dried matrix, with the dried matrix preferably including the zein composition as a continuous phase; e.g., including the alpha-beta-gamma-containing zein as a “structural protein” of the dried matrix. By way of example, a useful dough for preparing an extruded food product may include at least 5 weight percent alpha-beta-gamma-containing zein based on a total weight of the dough on a dry basis, e.g., from 5 to 40 weight percent alpha-beta-gamma-containing zein per total weight dough on a dry basis.

A structural protein is a protein that is present in a food product as a structural component that holds a structure of the food product together and supports the food product, such as by being in the form of a continuous phase of a structural matrix of a food product. As an example, gluten can form a continuous phase of a matrix of cells that forms a dough or bread product, and is considered a structural component of the dough or bread product. In contrast, other ingredients of a food product as described herein or more generally, including proteins, may alternately be present in a food product to provide flavor, as a non-structural filler, or to provide nutritional value or as fiber; in such functions a food ingredient (which may be protein) is not generally present as a continuous phase of a structural matrix. Also for purposes of explanation, while gluten is an example of a protein that is widely useful as a structural protein in foods, other proteins are also capable of functioning as a structural protein. Recent consumer interest in foods that do not contain gluten or contain relatively low amounts of gluten have caused food scientists to avoid gluten and identify food ingredients that can be useful as alternatives to gluten.

In some more specific embodiments of food products as described, including extruded food products as described, useful amounts of the alpha-beta-gamma-containing zein (based on solids) may be from as low as about 4 or 5 weight percent alpha-beta-gamma-containing zein based on a total weight of solids in a food product (i.e., on a dry solids basis, exclusive of any water contained in the food product), or from about 6, 7, 8, 9, or 10 to about 20, 25, 30, or 40 weight percent of the alpha-beta-gamma-containing zein based on total weight solids of the food product. These ranges may be particularly useful for forming a desirable flavored expanded snack or cereal food product by an extrusion method. Alternately, higher amounts of the alpha-beta-gamma-containing zein may also be useful and are within the contemplation of the present description, such as amounts up to and including about 50, 60, 70, 80, or 90 weight percent based on a total amount of solids in a food piece or food composition.

An expanded food product can be a food product that includes a solid dried (relative to a dough, but still containing some amount of water) matrix that defines open cells. Exemplary expanded (also referred to herein as “puffed”) food products can be in the form of individual food pieces, each having a cellular structure made of open or closed cells defined by cell walls referred to herein as a “matrix.” The matrix is made of the expanded and typically dried dough that includes the alpha-beta-gamma-containing zein composition, preferably as a continuous phase, e.g., acting as a structural support of the matrix and food piece. The dried food piece is preferably “self-supporting,” meaning that each piece is sufficiently dry and rigid to support its own weight. The food product has a water content that is sufficiently low to exhibit crisp or frangible mechanical properties.

The amounts of other ingredients in a food product, e.g., an expanded food product, can be as desired. These ingredients, e.g., carbohydrates (e.g., flour and starch), fiber, fat (e.g., solid fat or oil), additional protein, flavorant (sugar, cheese, etc.), and the like, can be included in a dough or food product at any desired level, as may vary based on the particular type of food product. According to certain embodiments, the food product can contain relatively low amounts of gluten, or may be considered to be “gluten-free,” e.g., can contain no concentrated gluten ingredient and no gluten-containing ingredients, e.g., may contain less than 1 percent, e.g., less than 0.5 or 0.3 weight percent total gluten based on total solids of the food product.

Water can be present in a dried (relative to a dough used to form the dried food product) food product or dried food piece as described herein at any useful concentration, with exemplary amounts of water being in a range from about 1 to about 7 weight percent, e.g., from about 2 to about 5 weight percent, based on the total weight of the dried food product or piece. The amount of water may vary depending on the desired composition and physical properties of the dried food product or food piece.

An expanded food product as described can be in the form of an individually formed food piece that includes a solid and dried matrix (which may include some amount of water) that defines numerous openings or “cells” (air pockets or open spaces) interspersed between the walls forming a matrix that defines the cells, giving the expanded food piece a high porosity and reduced density Expanded or “puffed” snack food products are popular consumer items for which there exists strong demand. Examples include low density snack or cereal products such as those commercially available as Baked Cheetos®, Puffed Cheetos®, and similar expanded corn-based cheesy snack foods, as well as Kix® and Cheerios® brand breakfast cereals. Example puffed, extruded, or expanded snack food products, and methods of their preparation, are described in United States patent and Patent Publication Numbers U.S. Pat. Nos. 6,797,213; 6,722,873; 2006/0019009; 2011/0200736; and 2013/0040040, the contents of which are incorporated herein by reference in their entireties. As exemplary densities (without limiting the scope of the expanded products described herein), some low density snack food products may have a density in a range from about 0.02 g/cm³ to about 0.7 g/cm³ and, or from about 0.02 g/cm³ to about 0.5 g/cm³. Expanded food products are popular among consumers because of their convenience and because of their textural attributes. The texture of a finished product is highly dependent on the cell structure of the food. The number of cells, the cell size and the thickness of the cell walls contribute to the texture of the finished product. The cellular structure affects the amount of force required to break the food during mastication. It also affects the intensity and the frequency of the fracture events happening during chewing. Depending on the number and the intensity of the fracture events, the consumer will describe the food as either crispy or crunchy. For example, a breakfast cereal has a tight cellular structure and is a crunchy product. Corn based cheesy puffed snacks typically have an airier cell structure and thinner cell walls and are perceived as crispy foods.

As one proviso, the food products (e.g., extruded, puffed, or expanded food products) described herein and prepared from an alpha-beta-gamma-containing zein composition are understood to not include popcorn. For purposes of this description, the term “popcorn” is used in its conventional sense to refer to a natural edible corn product prepared by heating a corn kernel to pressurize the starchy interior sufficiently to cause the kernel to explode or “pop.” Popcorn includes zein, generally including all three forms of alpha-, beta-, and gamma-zein, and may include these three forms of zein in relative amounts that can overlap specific amounts of these three zein forms identified herein with the described alpha-beta-gamma-containing zein compositions. Natural popcorn, either popped or unpopped, being previously known, is not within the scope of the presently described or claimed food products or related methods.

The extruded, puffed, or expanded food products containing alpha-beta-gamma-containing zein composition may be produced by any known or developed method of preparing a water-containing dough (containing an amount of the alpha-beta-gamma-containing zein composition and other desired ingredients, with water), and processing the dough at elevated temperature, pressure, and shear by use of an extruder. An amount of volatizable agent such as water or other plasticizing agent (e.g., a polyhydric alcohol such as glycerol or the like) can be included in the dough in an amount to allow the dough to flow through the extruder as a dough composition, followed by extrusion and expansion of the dough at the extruder opening (e.g., die). Amounts of water in a range of from about 13 to about 30 weight percent, based on the total weight of the dough (water and solids), may be useful in a dough, but other amounts may also be useful.

The extruder passes the dough under pressure and at an elevated temperature through a die or other opening. The volatizable agent, generally the water component of the dough, alternately steam, can become depressurized upon the dough exiting the extruder, causing the volatizable agent to expand, which in turn causes the dough to expand and form the cell-containing structural matrix. Certain exemplary methods of preparing a puffed extruded food product are described in U.S. Pat. No. 6,607,772, the entirety of which is incorporated herein by reference. That document describes extruding a dough that contains water, corn meal, and other desired ingredients through a die having a small orifice at high pressure to form an extrudate. The extrudate flashes off its inherent and added moisture, or puffs, as it exits the small orifice, thereby forming an expanded (puffed) extrudate upon reaching atmospheric pressure after extrusion.

Any suitable food extruder can be used, such as a single or twin screw extruder. The extruder heats the dough to a temperature sufficient to allow for desired flow, with exemplary operating ranges being at least about 95 degrees Fahrenheit. The pressure in the extruder can be any pressure useful to allow the dough to flow through the extruder and through the extruder opening to produce a desired extruded and expanded food product; examples of useful pressures may be at least about 200 or 400 pounds per square inch, up to about 700 or 800 pounds per square inch. The heated and pressurized dough can be forced through the extruder opening, upon which the heated water in the dough forms steam due to the pressure reduction upon exiting the extruder, resulting in an expansion or puffing of the extruded dough. The volumetric expansion at the extruder opening may be as desired, for example expansion in a range from about 2 and about 50 fold of the original volume. Also upon this expansion, the expanded dough may be cut, formed, or shaped, e.g., molded, into a desired shape and desired dimensions.

The product after extrusion, expansion, and optional cutting and shaping into an expanded dough piece can be dried by any known method to reduce water content. Before or after drying, the extruded food pieces may be processed by application of a coating, if desired, such as a flavor coating. The coating can be applied by any useful method such as by spraying, tumbling, or any other suitable application technique.

### EXAMPLES

### Example 1

According to the following examples, different protein materials were processed into a foam to determine Foaming Capacity (FC) and Foam Stability (FS). Zein Composition 1 and Zein Composition 2 are alpha-beta-gamma-containing zein compositions prepared according to methods of the '013 patent and contains 22 and 24% β+γ zein (based on total zein), respectively, and 78 and 76% α-zein (based on total zein). FREEMAN ZEIN is a zein protein material commercially available from Freeman Industries and contains essentially only the alpha-zein form. SPI is a concentrated soy protein isolate product, and casein is a concentrated casein product. SPI and casein were obtained from MP Biomedicals, 29525 Fountain Parkway, Solon, Ohio 44139.

The results show that Zein Composition 1 and Zein Composition 2 have useful Foaming Capacity and Foaming Stability, and that these properties of Zein Composition 1 and Zein Composition 2 are substantially better than those of FREEMAN ZEIN.

| Protein | |
|---|---|
| Zein Composition 1 | 22% β + γ zein, 78% α-zein |
| Zein Composition 2 | 24% β + γ zein, 76% α-zein |
| FREEMAN ZEIN; | Alpha-zein |
| commercially | |
| available from | |
| Freeman Industries | |
| SPI | Soy Protein Isolate MP |
| Casein | Purified High Nitrogen MP |

### Foaming Capacity and Stability (FC and FS)

Foaming capacity (FC) and foam stability (FS) were determined using the methods of Ogunwolu (et al. 2009): Ogunwolu, S. O., Henshaw, F. O., Mock, H. P., Santros, A., and Awonorin, S. O. Functional properties of protein concentrates and isolates produced from cashew nut. Food Chem. 115:852-858. The procedure was performed in triplicate for each protein. Two hundred and fifty milligrams of each protein was mixed with 250 mL of cold (5-10° C.) DI water, and the pH was adjusted to 3, 7, and 9 using 0.1N HCl or 0.1N NaOH. The protein solution was blended for three minutes in a Waring 700G commercial blender (model WF2212112). The whipped solution was poured into either a 500 ml or 1000 ml graduated cylinder depending on how the protein foamed. The total sample volume was measured at 0 min for FC and at 60 min for FS. FC and FS were then calculated:

$$FC = \frac{( volume after whipping - volume before whipping ) ml}{( volume before whipping ) ml}$$

$$FS = \frac{( volume after standing - volume before whipping ) ml}{( volume before whipping ) ml}$$

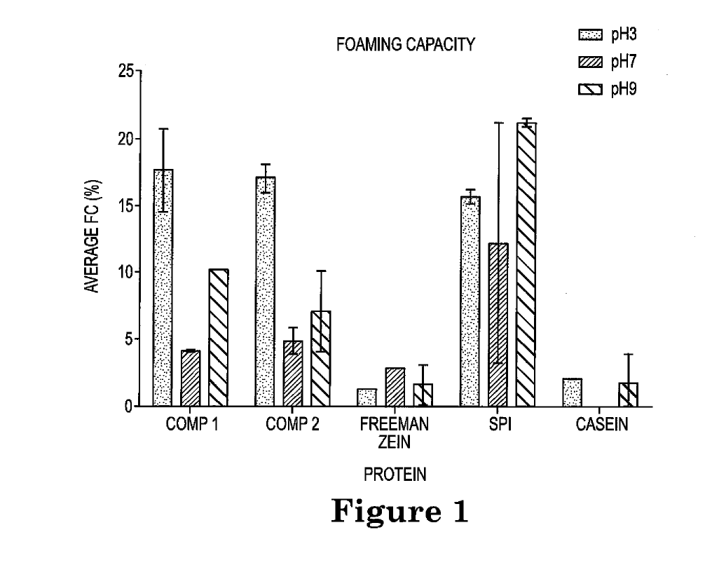

The results of the FC testing for the proteins tested are summarized in Table 1 and graphically represented in FIG. 1. The pH at which SPI, casein, and FREEMAN ZEIN were tested significantly affects FC. There was a trend for FC to increase at pH 3 and 9 for all of the proteins tested, except for FREEMAN ZEIN, pH had a significant effect on the FC for the Zein Composition 1 and Zein Composition 2 examples. At pH 3, the FCs for the Zein Composition 1 and Zein Composition 2 examples were statistically equivalent to that of SPI. The FCs for Zein Composition 1 and Zein Composition 2 were much greater than that of FREEMAN ZEIN. This may be because the Zein Composition 1 and Zein Composition 2 examples contain beta- and gamma-zein. The beta- and gamma-zein proteins are more hydrophilic than alpha-zein when compared to the grand average of hydropathicity (Kyte and Doolittle 1982). Because of their more hydrophilic natures, beta- and gamma-zein may exhibit a greater ability to reduce the surface tension of water than alpha-zein. This hypothesis is supported by the fact that the FCs of Zein Composition 1 and Zein Composition 2 are higher at pH 3 and 9. At pH 3 and 9 the Zein Composition 1 and Zein Composition 2 examples would carry more charge and probably be more soluble than FREEMAN ZEIN.

TABLE 1
Average FC at pH 3, 7, and 9. (In the tables, means within a column
not sharing an upper case letter are significantly different
(P < 0.05). Means within a row not sharing a lower
case letter are significantly different at (P < 0.05)).

| Protein | pH 3 | pH 7 | pH 9 |
|---|---|---|---|
| Zein Composition 1 | 17.60% A a | 4.04% A B b | 10.20% B b |
| Zein Composition 2 | 16.98% A a | 4.86% A B b | 7.06% B C b |
| FREEMAN ZEIN | 1.20% B a | 2.82% A B a | 1.60% C a |
| SPI | 15.61% A a | 12.15% A a | 21.18% A a |
| Casein | 2.01% B a | 0.00% B a | 1.76% C a |

The FS after 60 minutes was minimal for all of the proteins evaluated (Table 2). Only SPI measured at pH of 3 and 9 were significantly greater than zero. For a foam product to be prepared from Zein Composition 1 or Zein Composition 2, a foam stabilizer can be included. Because the FS is low, processing with Zein Composition 1 and Zein Composition 2 can be managed with minimal issues.

TABLE 2
Average FS values after 60 min. (%) at each pH
value. Means within a column not sharing an upper
case letter are significantly different (P < 0.05)

| Protein | pH 3 | pH 7 | pH 9 |
|---|---|---|---|
| Zein Composition 1 | 1.51% A | 1.20% A | 2.04% A |
| Zein Composition 2 | 2.06% A | 1.20% A | 2.16% A |
| FREEMAN ZEIN | 0.40% A | 1.34% A | 0.67% A |
| SPI | 5.01% B | 2.29% A | 4.21% A |
| Casein | 0.00% A | 0.00% A | 0.00% A |

### Example 2

This example illustrates the production of an extruded cereal product containing zein. Zein Composition 3 is an alpha-beta-gamma-containing zein product prepared according to methods of the '013 patent and contains 23% β+γ zein (based on total zein) and 77% α-zein (based on total zein). FREEMAN ZEIN is a zein protein material commercially available from Freeman Industries and contains essentially only the alpha-zein form.

Blends of dried ingredient were prepared according to Table 3.

TABLE 3
Composition of blends (percentage of total recipe)

| | |
|---|---|
| A | B |

| Ingredient | Control | 1 | 2 | 1 | 2 |
|---|---|---|---|---|---|
| Whole corn flour | 51 | 51 | 51 | 51 | 51 |
| Yellow corn meal | 37 | 37 | 37 | 7 | 7 |
| Sugar | 10 | — | — | — | — |
| Salt | 2 | 2 | 2 | 2 | 2 |
| FREEMAN ZEIN | — | 10 | — | 40 | — |
| Zein composition 3 | — | — | 10 | — | 40 |

The moisture content of the blends was adjusted to 13.6%. The blends were extruded using a single screw extruder (C. W. Brabender Plasti-Corder, Model PL 2000) fitted with a 38 cm long barrel. The die head was fitted with a 4 mm die. The screw compression ratio was 3:1. The temperature of the feed zone was set at 80° C., the temperature of the transition zone was set at 145° C., and the temperature of the die zone was set at 145° C. Extrudates of each blend were collected and dried overnight in a forced air oven set at 50° C. to reduce the moisture content to 2% or less.

The expansion ratio, bulk density, and texture attributes were used to characterize the extrudates. The cross sectional diameters of the extrudates were measured using a Vernier caliper and the expansion ratio was measured:

$$Expansion ratio = \frac{Cross sectional diameter of extrudate ( mm )}{Diameter of die opening ( mm )}$$

The bulk density was evaluated using a volume displacement method. A wide mouth glass jar was filled with mustard seeds, the surface was scraped with a ruler to remove the excess seeds. The volume of the mustard seeds was measured using a 250 ml graduated cylinder. Ten grams of each extrudate were weighed. Each sample of extrudate, and the mustard seeds were added slowly to the glass jar. The jar was tapped against the countertop to ensure that the voids were filled. When enough seeds were added to fill the jar, the excess seeds were removed by scraping the surface with a ruler. The difference between the volume of mustard seeds required to fill the empty glass jar and the volume of seeds required to fill the jar containing an extrudate represents the volume occupied by an extrudate. The bulk density was calculated:

$$Bulk density = \frac{Mass of dried extrudate ( g )}{Volume occupied by extrudate ( ml )}$$

The results for the expansion ratio and the bulk density are summarized in Table 4.

TABLE 4
Average expansion ratio and bulk density of the
extrudates. Means within a column not sharing
a letter are significantly different (P < 0.05)

| | | Bulk density |
|---|---|---|
| ID | Expansion ratio | (g/ml) |
| Control | 2.55 cd | 0.2898 a |
| A1 | 2.88 bc | 0.1958 b |
| A2 | 3.35 a | 0.0963 d |
| B1 | 2.39 d | 0.1175 cd |
| B2 | 3.04 ab | 0.1385 c |

The addition of zein increased the expansion ratio and lowered the bulk density. The extrudates A2 and B2 made using the alpha-beta-gamma-containing Zein Composition 3 had a significantly higher expansion ratio in relation to the control and to the extrudates containing FREEMAN ZEIN (A1 and B1). The extrudates of B1, made with FREEMAN ZEIN were significantly smaller than the control. The example blends that contained high levels of FREEMAN ZEIN were more challenging to process and did not flow through the extruder as well the example blends containing the alpha-beta-gamma-containing zein. The FREEMAN ZEIN extrudates (B1) were not homogeneous in size. Some of the B1 extrudates showed signs of collapse. These results suggests that the alpha-beta-gamma-containing zein performs better during extrusion and that it may function as a structural protein in the finished puffed product.

The texture of the extrudate was evaluated using a Texture Analyzer TA.XT.plus fitted with a cylindrical Plexiglas probe (TA-4, 30 mm in diameter). The texture of a single extrudate was evaluated using a compression test (70% strain). The maximum force recorded during the test is defined as the hardness of the extrudate. During compression of crispy or crunchy foods, the rupture of the cells within the food translates as peaks in the texture curve. Therefore, the number of peaks is directly related to the crispiness of the food. The results of the texture analysis are summarized in table 5.

TABLE 5
Average hardness of the extrudate and average number of
peaks observed during the compression test. Means within
a column not sharing a letter are significantly different (P < 0.05)

| | Hardness | |
|---|---|---|
| ID | (kg) | Peak count |
| Control | 3.05 a | 51.6 a |
| A1 | 1.55 b | 22.6 b |
| A2 | 1.41 bc | 45.2 a |
| B1 | 0.76 c | 38.6 ab |
| B2 | 1.54 b | 48.2 a |

The zein-containing extrudates were significantly less hard in comparison to the control. At the 40% inclusion level, the extruded product containing Zein Composition 3 retained better textural attributes. The extrudate containing FREEMAN ZEIN was brittle. The extrudates produced using the alpha-beta-gamma-containing zein had a higher peak count in relation to the extrudates made with the all alpha-zein. The puffed food produced with the alpha-beta-gamma-containing zein was a crispier food than its all-alpha zein counterpart. The higher number of peaks observed suggests that the extrudate made with the alpha-beta-gamma-containing zein had a tighter cellular structure which was similar to the structure observed in the control. The results indicate that the alpha-beta-gamma-containing zein plays a structural role in the cellular structure of the puffed food product.

1. A food product comprising a structural matrix defining openings between structural matrix walls, the structural matrix comprising zein present as a continuous phase of the structural matrix, the food product containing at least 6 weight percent total zein on a dry basis.

2. A food product as recited at claim 1, comprising flour and a concentrated zein ingredient.

3. A food product as recited at claim 1, comprising concentrated zein ingredient that contains at least 80 weight percent zein.

4. A food product as recited at claim 1, comprising less than one percent gluten.

5. A food product as recited at claim 1 wherein the zein contains from 40 to 88 weight percent alpha-zein, from 12 to 60 weight percent combined beta-zein and gamma-zein.

6. A food product as recited at claim 1 wherein the zein contains from 55 to 70 weight percent alpha-zein, from 2 to 8 weight percent beta-zein, and from 5 to 25 weight percent gamma-zein.

7. A food product as recited at claim 1 wherein the zein contains from 60 to 70 weight percent alpha-zein, from 3 to 7 weight percent beta-zein, and from 10 to 20 weight percent gamma-zein.

8. An edible dough mixture comprising zein that contains from 40 to 88 weight percent alpha-zein and from 12 to 60 weight percent combined beta-zein and gamma-zein.

9. A dough mixture as recited at claim 8 comprising at least 5 weight percent zein on a dry basis.

10. A dough mixture as recited at claim 8 comprising from 5 to 40 weight percent zein on a dry basis.

11. A dough mixture as recited at claim 8 wherein the dough mixture contains a concentrated zein ingredient comprising at least 80 weight percent zein on a dry basis.

12. A dough mixture as recited at claim 8 wherein the zein contains from 60 to 70 weight percent alpha-zein, from 3 to 7 weight percent beta-zein, and from 10 to 20 weight percent gamma-zein.

13. A dough mixture as recited at claim 8 wherein the zein contains from about 55 to 70 weight percent alpha-zein, from about 2 to about 8 weight percent beta-zein, and from about 5 to 25 weight percent gamma-zein.

14. A dough mixture as recited at claim 8, comprising less than one percent gluten on a dry basis.

15. A method of preparing an expanded food product comprising a structural matrix defining openings between structural matrix walls, the method comprising
providing a dough mixture comprising zein,
heating the dough mixture,
extruding the heated dough mixture, and
drying the extruded dough mixture to form a dried expanded food product.

16. A method as recited at claim 15 wherein the dried expanded food product comprises a structural matrix defining openings between structural matrix walls, the structural matrix comprising zein present as a continuous phase of the structural matrix.

17. A method as recited at claim 15 wherein the dried expanded food product contains at least 6 weight percent zein on a dry basis.

18. A method as recited at claim 15 wherein the dough mixture comprising flour and a concentrated zein ingredient.

19. A method as recited at claim 18 wherein the concentrated zein ingredient contains at least 80 weight percent zein.

20. A method as recited at claim 15 wherein the zein contains from 40 to 88 weight percent alpha-zein, from 12 to 60 weight percent combined beta-zein and gamma-zein.
